(19) United States
(12) Patent Application Publication
(10) Pub. No.: US 2018/0157679 A1
(43) Pub. Date: Jun. 7, 2018

(54) METHOD AND DEVICE FOR USING DATABASES KEYED TO PHYSICAL ADDRESSES

(71) Applicant: David R. Denis, Lincolnshire, IL (US)

(72) Inventor: David R. Denis, Lincolnshire, IL (US)

(21) Appl. No.: 15/369,487

(22) Filed: Dec. 5, 2016

(51) Int. Cl. G06F 17/30

(52) U.S. Cl. CPC G06F 17/30241; G06F 17/30321

(57) ABSTRACT

A method for improving the targeting of communications with occupants of particular addresses by storing information in a database keyed on particular addresses and not related to the instant occupant of the address is disclosed. Further disclosed is a device which implements this method and automatically performs the method. An improved embodiment of the method and the implementing device with additional features enhancing the functionality of the method and device are also disclosed.

This invention relates to a method for collecting and correlating information regarding physical addresses in a database and using that database to target communications to occupants of those addresses. An improved method wherein such databases are correlated with databases containing information about individuals who may occupy those addresses is also described. The invention extends to a device which implements the method(s.)

### BACKGROUND OF THE INVENTION

The present invention relates to the use of databases to provide useful and relevant information regarding characteristics of a given residential or business address. For purposes of this application, a physical location which can be uniquely identified by a postal service, a tax assessor, or other entity which has a known and consistent method for uniquely identifying such locations shall be referred to as an “Address.” The unique identifying information for a particular Address (for Addresses in the US, this is typically a street or PO Box number, a city, a state, and a ZIP Plus 4 code, though it can be a parcel number, a parcel description, a property tax identification number, latitude and longitude information, or any other reasonable identifying information) shall be referred to as the “(physical) location information” for that Address. A person or entity living at, conducting business at, or otherwise occupying or using a particular Address shall be referred to as an “Occupant” of that Address. An Address may have one or more Occupants and a person or entity may be an Occupant of more than one Address.

While using records of consumer demographics and basic geographic information (e.g. ZIP codes to identify particular neighborhoods) is an old and established technique in the art, such databases have historically contained specific and particular information about individual Addresses only in association with the Occupants of such Addresses. For example, it may be known through direct information or through observation of consumer transactions that the Occupant of a particular Address has a swimming pool. But historically the fact that that Occupant has a swimming pool has been stored as information related to the Occupant, not the Address.

This limitation provides several disadvantages. For example, political mailings may be targeted at ZIP code groupings, but due to the way political districts are drawn, Addresses in the same ZIP code may or may not be in the same voting district in any particular election while still being in the same voting district for other elections. Buildings in any given ZIP code may also vary from businesses, to single family residences, to government buildings, to apartment complexes, et cetera. This makes it inefficient to try to communicate with voters having particular concerns and/or in particular voting districts as targeting their ZIP codes may result in communication with many Occupants whose Addresses are not in the voting district of concern or whose concern regarding a particular issue is lower due to particular circumstances associated with their Address.

Further, other customary forms of databases used for these purposes are keyed on individuals. It may be known that the Occupant of a particular Address has a swimming pool, but if the database is keyed on individuals and that individual moves, steps must be taken to insure that any targeted communication regarding swimming pools is not sent to them unless and until it is confirmed they have one at their new Address. If a new individual moves to that Address, similarly their entry in any such database will not reflect that they now have a swimming pool until it is updated with respect to the new Occupant. And if a person is an Occupant of more than one Address, organizing the data in this way can result in information being sent to them multiple times or causing confusion about which Address is the appropriate one to associate with that person for any particular purpose.

A method and device that will allow the use of a database keyed to Addresses to provide relevant communications with the Occupants of those Addresses independently of what else may or may not be known about those Occupants will be a useful invention. A method and device that will reduce the number of communications made to Occupants which are of lesser or no relevance to them due to their Address will also be a useful invention. Furthermore, a method and device that will allow the correlation of multiple databases, including a database keyed to Addresses and a database keyed to individuals who may be Occupants of those Addresses, to provide relevant communications with the Occupants of those Addresses will be a useful invention.

### SUMMARY OF THE INVENTION

Among the many objectives of the present invention is the provision of a method for obtaining a database which provides improved availability of information regarding particular Addresses and allows relevant communications to be sent to the Occupants of those Addresses even absent information about the particular Occupants.

A second objective of the present invention is a method which allows the obtaining and correlation of information in multiple databases, one of which contains information keyed to particular Addresses in such a way that both are useful, but when combined produce a new and novel expansion of the usefulness of the databases.

Another objective of the present invention is the provision of a device which implements the methods described above.

These and other objectives of the invention (which other objectives become clear by consideration of the specification and drawings as a whole) are met by providing a method and an embodying device

The objectives of the invention are further met by providing an improved method and embodying device which obtains and correlates information in two separate databases, one of which is keyed to particular Addresses and one of which is keyed to demographic or consumer information.

For purposes of this application, the background of the invention and the invention itself will be primarily described in terms of consumer marketing, but the problems exist in, and the invention is useful for, analogous fields and activities wherein it is desired to target communications to recipients who are most likely to take an interest in them.

### BRIEF DESCRIPTION OF THE DRAWINGS

FIG. 1 depicts a process flow diagram showing an embodiment of the method of the claimed invention.

FIG. 2 depicts a process flow diagram of an improved embodiment of the method of the claimed invention.

FIG. 3 depicts an abstracted schematic for a digital computer serving as a device which implements the method(s) of the claimed invention.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front may be used with respect to the drawings. These and similar directional terms are not to be construed to limit the scope of the invention in any manner. The words attach, connect, couple, and similar terms with their inflectional morphemes do not necessarily denote direct or intermediate connections, but may also include connections through mediate elements or devices.

For purposes of this application, users of the invention are said to “obtain” data, databases containing data, and/or access thereto. Data may be obtained by compiling it from individual pieces of information made available to or sought out by the user over time, renting or buying it commercially, obtaining it from a non-commercial source such as the US Census Bureau, or in any other reasonable manner. Gaining access to a database stored on a computer server belonging to another party via the global computer network or other electronic means may also be considered “obtaining” a database. A particular embodiment of the invention may include the step of collecting data and putting it into a database and/or the step of buying or renting access to a database of data already collected by the user or some other party. Otherwise, for purposes of this application no distinction is made between a database containing information collected by the user or any other party involved in the utilization of the method, or one obtained from some other source.

It should be noted that certain steps of the method(s) comprising the claimed invention may be performed in more than one order without changing the result or the efficacy of the overall method. As is known to persons of ordinary skill in the art, particular steps of comparison and/or selection of records from databases may be performed in any reasonable order. Also, if records from one database are selected and compared to records in another database, as is known to persons of ordinary skill in the art, the particular database from which the records are selected from first is often unimportant so long as the comparison steps are performed in a reasonable order. So long as the steps of comparison and/or selection are performed in an order which produces the results reasonably anticipated by the method of the claimed invention, any combination of selection and comparison steps incorporating every material step of the method of the claimed invention is equivalent to the method of the claimed invention. It is preferred, but not required, to select records in such a way as to minimize the total number of comparisons which must be performed in the execution of the method of the claimed invention. It is strongly preferred to select records and perform comparisons in such a way as to 1) minimize the bandwidth required to move the information regarding Addresses, as required for each step; and 2) minimize the amount of processing time required to perform the method.

It should be noted that depending on the exact resources and techniques used to implement the method of the claimed invention, a selection described herein as producing a new database or new group of records may be equivalently performed by flagging, marking, or otherwise tracking the selected records in existing databases. The tracked records are collectively equivalent to the new group of records or new database described herein. Similarly, if reference is made to transferring a record from one database to another, it should be understood that such transfer may not include every field stored in the record as stored in the originating database. It is obvious to only transfer the fields relevant to the desired output to an output database, and so long as the field(s) necessary to perform the method(s) is(are) transferred and/or tracked, such transfer or tracking is equivalent to transferring or tracking the entire record for purposes of the invention.

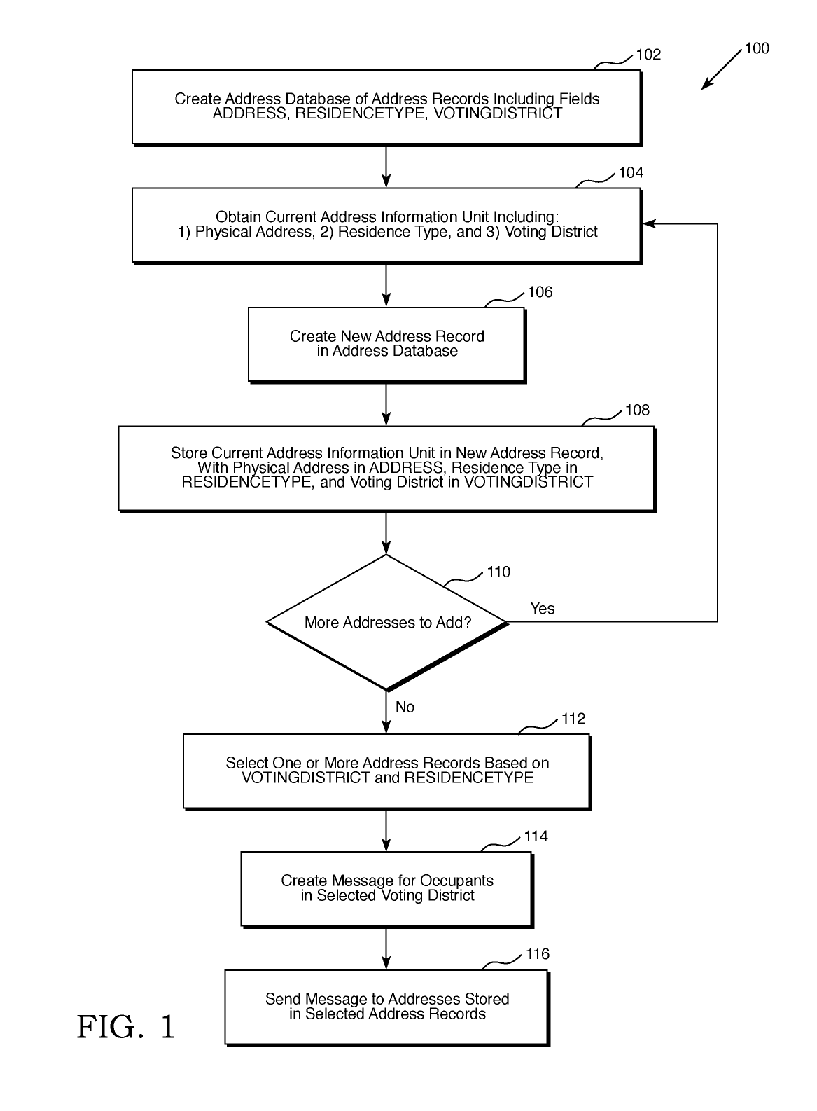

Now adding FIG. 1 to the consideration, the specific embodiment of the process and function of the disclosed invention, comprising the series of steps identified as method 100 can be easily understood.

In database creation step 102, the user creates, by any reasonable means, an Address Database for the storage of Address Records. Address Records are individual collections of information about an Address. Each Address Record has at least two fields and each field is an Address Record Field which contains discrete pieces of data such as a ZIP Plus 4 code, a voting district, a school district, et cetera. It is required that Address Records contain at least: 1) one or more fields for storing the physical location information of an Address, and 2) at least one other field for storing a piece of data related to that Address which is not part of the physical location information for that Address. For purposes of this application, the Address Record Field(s) which contain(s) the location information of an Address shall be referred to collectively as the “Address Field” or the “Unique Physical Location Field.” Any reference to an “Address Field”, “Unique Physical Location Field,” or similar field is understood to include either a single Address Record Field which stores an Address' physical location information, or a group of multiple Address Record Fields which together store an Address' physical location information.

In the description of the first preferred embodiment, each Address Record contains the following Address Record Fields: 1) an Address Field called ADDRESS; 2) a Residence Type Field called RESIDENCETYPE which stores information about the type of building(s) at the address (e.g. single family residence, apartment, condominium, et cetera,) and 3) a VOTINGDISTRICT field which stores information about what voting district(s) the Address is in, where a “voting district” is any desired political unit such as a Congressional district. “Voting District” and “Residence Type” are used only as examples. The actual contents of the fields other than the Address Field are unimportant for purposes of the claimed invention, but it is required that at least one such field must exist and that data must be stored in it. Also, a “Residence Type” field may contain designations for retail businesses, warehouses, manufacturing, offices, et cetera, even though these are not actual residences.

It is required that Address Records NOT contain information regarding the current or past Occupants of the Address, as this information is not necessary to the method and results in the use of resources for storing extraneous information and extra bandwidth and computer processing time being used to transport and process extraneous information. It is strongly preferred that the Address Database take the form of a database usable with a digital computer, such as a MySQL® or a Microsoft Access® database.

MySQL® is a registered United States trademark, U.S. Pat. No. 2,713,476, owned by MySQL AB, a company organized under the laws of the Country of Sweden, Bangardsgatan 8 Uppsala Sweden, SE-75320.

Microsoft Access® is a registered United States trademark, U.S. Pat. No. 1,741,086, owned by Microsoft Corporation, a corporation organized under the laws of the State of Delaware, One Microsoft Way, Redmond, Wash., 98052.

The non-location-information data may include “hard” characteristics, such as physical properties of an address which change infrequently if at all. These might include such things as the acreage/square footage of the Address, whether it has a swimming pool, free-standing garage, or other structure(s,) or permanent properties of those structure(s) such as a fireplace. It may also include, both additionally or exclusively as desired, “soft” characteristics of the Address which may either change frequently and/or are not directly related to the physical properties of the Address or any structures thereon. These might include such things as the current zoning of the Address, the primary and/or secondary school district to which it is currently assigned, or other information such as a history of use for public or senior housing.

In Data Acquisition Step 104, a Current Address Record is obtained, either by physically writing down information, obtaining access to an existing database, construction by examination of multiple pre-existing records or databases, or any other reasonable means. It is required that the Current Address Record include at least: 1) the location information for a single Address, and 2) at least one other piece of data related to that Address which is not part of the location information for that Address. It is required that the at least one other piece of data be that which is to be stored in the at least one other field of an Address Record. Here, the Current Address Record includes the physical address of a particular Address, the Residence Type of that Address, and the Voting District of that Address. It is required that the Current Address Record contain the three pieces of information (or however many and whatever type are actually used) in a format ultimately compatible with the fields of the Address Database.

In Address Record Creation Step 106, a new blank record is created in the Address Database.

In Address Record Data Input Step 108, the Current Address Record is stored in the new blank record of the Address Database. Each piece of information is entered into the corresponding Address Record Field. This may be done by typing, by copying and pasting, by insertion through database operations, or by any other reasonable input method.

In Continuation Step 110, it is determined whether there are more Current Address Records to add to the Address Database. This is true if there are more Current Address Records which are to be entered into the Address Database and false if there are not. If it is true, a new Current Address Record is obtained and steps 104 through 110 are repeated. If not, the method continues to the next step.

Note that steps 102-110 may be condensed into a single “Obtain an Address Database” step if a pre-existing database is obtained by purchase, rental, or other reasonable means. It is required, if this is done, for the Address Database to be purged of any information related to the current or past Occupants of each Address for reasons explained in the description of Database Creation Step 102. It is also required that the Address Database contain the at least one non-location field, so if the pre-existing database does not contain such a field, it must be added and populated with non-location related data.

In Selection Step 112, one or more Address Records are selected from the Address Database based upon a desired combination of Voting District and Residence Type (or other non-location related data.) For instance, a selection of all Single Family Residences in the First Congressional District can be made.

In Message Creation Step 114, a message is created for Occupants of Addresses meeting the required selection parameters. In the example given, a message is created for all Occupants of Single Family Residences in the First Congressional District. Since no identifying information for the Occupants is stored, such message is required to be addressed to “Occupant,” or other nonspecific person or entity. In the example given, “Homeowners in the First Congressional District should be aware of a new law proposed by your Congressional Representative” can be a reasonable introduction to such a message.

In Message Transmission Step 116, the message is transmitted to the Addresses corresponding to the Address Records selected in Selection Step 112. This can be done by traditional mass mailing techniques, by handwriting address labels and affixing them to cards containing the message, or by any other reasonable means.

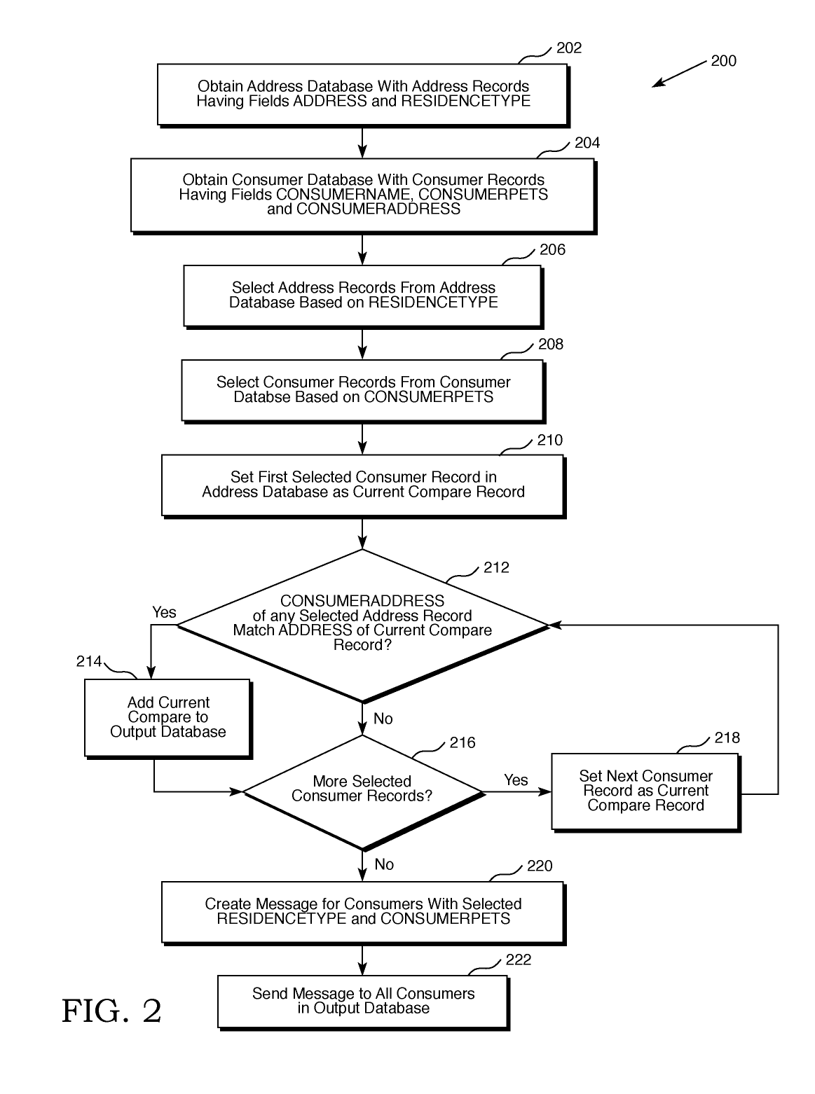

FIG. 2 shows an improved embodiment 200 of the claimed invention, comprising an extended method for using an Address Database as previously described. Note that while this is analogous to the Address Database of FIG. 1, FIG. 2 describes an alternate embodiment and this Address Database may or may not be substantially similar in form or content to the Address Database of the prior example in FIG. 1.

In Address Database Acquisition Step 202 of this method, an Address Database is obtained. It may be obtained by any desired means, including but not limited to, creating it from scratch in a manner similar to that shown in FIG. 1, steps 102-110. In this embodiment, only one other fact about the Address besides the physical address (for example, its Residence Type) is required, although multiple additional facts can be part of the Address Record (for example school district, property size, presence of a swimming pool, or any other property related attribute) and may be included for the purpose of narrowing results. All such facts are stored in appropriate Address Record Fields such as ADDRESS, RESIDENCETYPE, and VOTINGDISTRICT. Again, it is required that the Address Database not contain particular information about any current or past Occupant of the Addresses stored therein.

In Consumer Database Acquisition Step 204, the current example depicts a Consumer Database comprised of Consumer Records (also referred to as Consumer Data Records) including the consumer name, pets, and physical location, and these values are obtained in a manner similar to that described previously. Note that the value pets (CONSUMERPETS) is utilized as an example only and any data point may be created for any desired value. These values are stored in corresponding Consumer Record Fields with identifying names, in this example, CONSUMERNAME, CONSUMERPETS, and CONSUMERADDRESS. It is required that CONSUMERADDRESS be utilized for comparison with the Address Record Database and must store the consumer's physical location in a manner consistent with, and reasonably comparable to, the way that the physical location of an Address is stored in the ADDRESS Field (see FIG. 1 for Address Field description) of the Address Database. CONSUMERADDRESS may be a single field or a plurality of fields which together store the consumer's physical location. CONSUMERNAME is required only if a personalized message is desired when creating a message for consumers.

In Address Record Selection Step 206, Address Records are selected from the Address Database in accordance with a desired parameter regarding the selected Addresses. For example, a selection of all Address Records which correspond to Single Family Residences can be made. These selected Address Records can be output to a new table or database, or simply marked as records for comparison in the Address Database.

In Consumer Record Selection Step 208, Consumer Records are selected from the Consumer Database in accordance with a desired parameter regarding the selected consumers. For example, a selection of all Consumer Records which correspond to consumers having a dog can be made. These selected Consumer Records can be output to a new table or database, or simply marked as records for comparison in the Consumer Database.

In Initialization Step 210, the first selected record of the Consumer Database is set as the record to be compared, i.e. the Current Compare Record, for purposes of the method of the claimed invention.

In Comparison Step 212, the Current Compare Record is compared to all the selected Address Records from Address Record Selection Step 206. If no match is found, the method continues to Proceed Confirmation Step 216.

If a match is found, the Current Compare Record is placed in an Output Database (or equivalently marked as a matching Consumer Record) in Output Step 214. The method then continues to Proceed Confirmation Step 216.

Note that depending on the relative sizes of the Consumer Database and the Address Database and the selections made therefrom, it may be preferable to reverse this process, i.e. setting the first selected record of the Address Database as the Current Compare Record, and comparing the Consumer Records to it. This will produce an equivalent Output Database. Some database programs also have the ability to select from multiple databases in a single operation, with selection parameters being applied to both simultaneously. Performing such an operation is equivalent to selecting from both databases separately and comparing the results, and will produce an equivalent Output Database.

In Proceed Confirmation Step 216, the method checks to see if there are additional selected Consumer Records which have not yet been compared through Comparison Step 212. If so, it designates the next such Consumer Record as the Current Compare Record in Next Record Selection Step 218 and repeats steps 212 to 216. If not, it proceeds to Message Creation Step 220.

In Message Creation Step 220, a message is created for Occupants of Addresses meeting the required selection parameters. In the example given, a message is created for all Occupants of Single Family Residences who have a dog. As opposed to the embodiment of FIG. 1, in the embodiment demonstrated in FIG. 2, the Current Compare Record is created to include the name of the Occupant which is known from the Consumer Database. Thus, the Message for Consumers sent to Consumers in the Output Database may be personalized if desired.

Note that the actual message may be created at any time in the process prior to Message Transmission Step 222, although personalization of all messages cannot be completed prior to the completion of the Output Database (i.e. when Proceed Confirmation Step 216 has a negative answer.) Messages may be created and/or personalized as each Output Database record is created, or in bulk at the end of the Output Database creation sub-steps.

In Message Transmission Step 222, the message is transmitted to the Addresses corresponding to the records added to the Output Database. This can be done by traditional mass mailing techniques, by handwriting address labels and affixing them to cards containing the message, or by any other reasonable means.

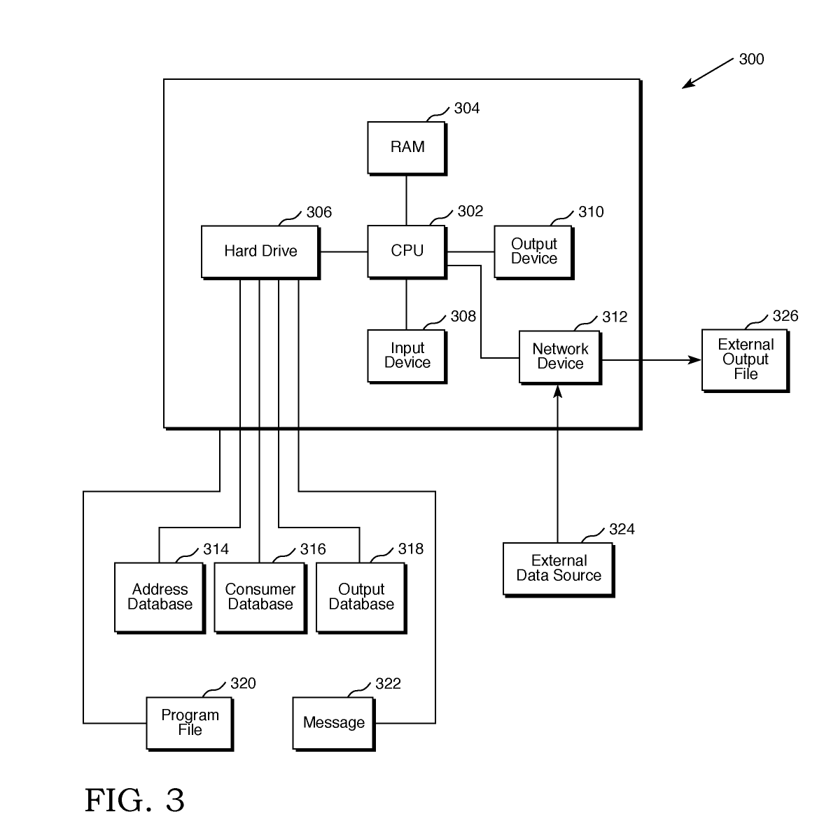

FIG. 3 shows an abstracted device schematic embodying the claimed invention, specifically the improved embodiment described in FIG. 2. Computer 300 is comprised of central processing unit CPU 302, random access memory RAM 304, persistent storage Hard Drive 306, Input Device 308, Output Device 310, and Network Device 312. There are many ways to configure and implement Computer 300 which are well known to those of ordinary skill in the relevant art. For purposes of this application, Hard Drive 306 is assumed to be a magnetic platter storage unit, but can be flash RAM or any other desired means of persistent storage. Input Device 308 is presumed to be a keyboard, but can be any desired input device such as a touch screen or a CD-ROM drive and multiple input devices such as a keyboard and a mouse can be used. Output Device 310 is presumed to be an LCD display, but can be a CRT display, an e-ink display, a printer, or any other desired output device or combination of devices. Network Device 312 is presumed to be an Ethernet interface, but can be a wireless networking interface, a modem, or any other desired network connectivity device.

Address Database 314 and Consumer Database 316 are stored on Hard Drive 306. They may be directly copied to it, or the data stored therein may be input by a user through Input Device 308. They may also be transferred to it through Network Device 312. Also, stored on Hard Drive 306 are Program File 320 and Message 322. Both Program File 320 and Message 322 may be input directly through Input Device 308, or copied to Hard Drive 306 through any desired means, including Network Device 312.

To use the device, a user initiates Program File 320 by issuing an initiation command through Input Device 308. Program File 320 contains a series of instructions executed by CPU 302. These instructions execute the steps of method 200, asking for input from the user where appropriate such as in Address Record Selection Step 206, Consumer Record Selection Step 208, and Message Creation Step 220. It is obvious to present the request for input to the user in the form of: 1) entirely open-ended inputs (e.g. a text box where the user may input a completely novel message or search parameter,) 2) partially or entirely fixed input selections (e.g. a popup menu with all allowed search parameters, or one or more semi-customizable messages,) or 3) a combination of these forms.

At the end of the execution of Message Creation Step 220, the instructions in Program File 320 may execute Message Transmission Step 222 in a variety of ways well known to persons of ordinary skill in the relevant art, including printing Message 322 on papers which may then be inserted into window envelopes such that the Address is visible and putting the envelopes in the mail, printing Message 322 on postcards which can be put in the mail, or providing a copy of Output Database 318 either through Output Device 310 or transmitting it through Network Device 312 to another computer (not shown) which can then process Output Database 318 and transmit Message 322 to the selected recipients.

If Consumer Database 316 contains email addresses, it is optional to transmit Message 322 through email via Network Device 312 either in addition to or instead of sending a physical copy of the Message through the mail. It is required that Output Database 318 include the corresponding email address so that Message 322 can be sent via email if this optional step is included. As above, Computer 300 can either transmit the Message itself or send a file or list of Messages and email addresses to another computer via Network Device 312.

It is optional to store Address Database 314, Consumer Database 316, Output Database 318, Program File 320, and/or Message 322 on another computer or storage device not connected directly to Computer 300. If any of these files are stored on another computer, they are accessed through Network Device 312 (see reference to External Data Source 324, which may represent any or all of these files.)

As discussed above, it is optional to offload Message Transmission Step 222 to another computer or device and perform that step remotely by sending Output Database 318, Message 322, or both to the other device. If this is done, it is done through Network Device 312 (see reference to External Output File 326, which may represent Output Database 318, Message 322, or any combination thereof.)

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this apparatus and method can become clear to a person having ordinary skill in this particular art. Such modifications are clearly covered by this disclosure.

What is claimed and sought to be protected by Letters Patent is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method for using a database keyed to physical addresses comprising:
a) Creating an address database capable of storing a plurality of address records, each address record having a plurality of address record fields, one of the plurality of address record fields being a unique physical location field able to store a unique physical address location;
b) Obtaining a plurality of address record data items, each address record data item comprising at least two facts, the at least two facts including a unique physical address identifier corresponding to a unique physical address and a second fact describing a non-physical location property of the unique physical address, wherein none of the at least two facts comprise a name or a unique identifier corresponding to a particular individual person;
c) Storing the plurality of address record data items in the address database such that, the at least two facts are stored in the plurality of address record fields, with the unique physical address identifier of the address record data item being stored in the unique physical location field and the second fact being stored in any of the other of the plurality of address record fields;
d) Selecting a first subset of the plurality of address records by evaluating at least one of the address record fields which is not the unique physical location field to see if the at least one address record field which is not the unique physical location field matches a specified condition;
e) Creating a targeted communication having a locational relevance such that the targeted communication will be of a higher level of locational relevance to a plurality of recipients at a relative locational relevance level determined by whether the recipient occupies one of the unique physical addresses corresponding to one of the unique physical address identifiers stored within one of the first subset of the plurality of address records; and,
f) Sending the targeted communication to all of the unique physical addresses corresponding to the unique physical address identifiers stored in the first subset within the plurality of address records.

18. The method of claim 17, wherein the second fact comprises a residence type identifier.

19. A device for using a database keyed to addresses comprising:
a) a digital computer comprising a CPU, a RAM and/or a persistent storage device, an input device, and a visual display, the RAM and/or the persistent storage device, the input device, and the visual display operably connected to the CPU;
b) an address database stored on the RAM and/or the persistent storage device, the address database comprising a computer file comprised of a plurality of address records, each of the address records comprised of a plurality of address record fields, one of the plurality of address record fields being a unique physical location field able to store a unique physical address location, wherein none of the plurality of address record fields store information correlated to a particular individual;
c) a consumer database stored on the RAM and/or the persistent storage device, the consumer database comprising a computer file comprised of a plurality of consumer records, each of the consumer records comprised of a plurality of consumer record fields, one of the plurality of consumer record fields being a unique consumer location field able to store a unique consumer address location;
d) a program file stored on the RAM and/or the persistent storage device, the program file comprising a set of instructions which are executed by the CPU and cause the digital computer to perform the following operations;
i. Access the address database;
ii. Select a first subset of the plurality of address records from the address database based upon the content of at least one of the address record fields which is not part of the unique physical location field;
iii. Access the consumer database;
iv. Select a first subset of the plurality of consumer records from the consumer database based upon the content of at least one of the consumer record fields which is not part of the unique consumer location field;
v. Create an output database by selecting all of the first subset of the plurality of consumer records in which the content of the unique consumer location field corresponds to the content of the unique physical location field stored in at least one of the address records in the first subset of the plurality of address records and putting the consumer records so selected into the output database;
vi. Create a targeted communication having a locational relevance such that the targeted communication will be of a higher level of locational relevance to a plurality of recipients at a relative locational relevance level determined by whether the recipient occupies one of the unique physical addresses corresponding to one of the unique physical address identifiers stored in one of the first subset of the plurality of address records; and,
vii. Output the targeted communication so that the targeted communication can be sent to the unique consumer address location stored in each consumer record stored in the output database.
